(19) United States
(12) Patent Application Publication
(10) Pub. No.: US 2024/0069418 A1
(43) Pub. Date: Feb. 29, 2024

(54) FOCAL LENGTH ADJUSTMENT MECHANISM

(71) Applicant: Qisda Corporation, Taoyuan City (TW)

(72) Inventors: Chin Fu Lee, Taoyuan City (TW); Chun Ming Shen, Taoyuan City (TW)

(73) Assignee: Qisda Corporation, Taoyuan City (TW)

(21) Appl. No.: 18/302,814

(22) Filed: Apr. 19, 2023

(30) Foreign Application Priority Data
Aug. 26, 2022 (CN) 202211034844.9

(51) Int. Cl. G03B 21/14; G03B 3/00

(52) U.S. Cl. CPC G03B 21/142; G03B 3/00

(57) ABSTRACT

A focal length adjustment mechanism, adapted for adjusting a focal length adjustment device located in a housing of a projector. The focal length adjustment mechanism includes a knob and a first stroke adjustment member. The first stroke adjustment member is located in the housing and includes a first end and a second end opposite to each other and a first pivot located between the first end and the second end. The first end is connected to the focal length adjustment device. The knob is connected to the second end. The knob rotates to drive the first stroke adjustment member to rotate around the first pivot. A distance between the first pivot and the first end is less than a distance between the first pivot and the second end, such that a movement path of the first end is less than a movement path of the second end.

### CROSS-REFERENCE TO RELATED APPLICATION

This application claims the priority benefit of China application serial no. 202211034844.9, filed on Aug. 26, 2022. The entirety of the above-mentioned patent application is hereby incorporated by reference herein and made a part of this specification.

### BACKGROUND

### Technical Field

The disclosure relates to an adjustment mechanism, and more particularly to a focal length adjustment mechanism.

### Description of Related Art

Generally, when using the projector, the focal length of the lens needs to be adjusted to make the projected image clear. As the size of the projector becomes smaller, the size of the internal space is limited, and light machines are developing towards miniaturization, which makes the lens of the light machines more difficult to focus. Therefore, how to facilitate users to adjust the focal length, and to provide more precise fine-tuning of the lens are the direction of research in the art.

### SUMMARY

The disclosure provides a focal length adjustment mechanism, which can provide external focusing and more precise fine-tuning.

A focal length adjustment mechanism of the disclosure is adapted for adjusting a focal length adjustment device located in a housing of a projector. The focal length adjustment mechanism includes a knob and a first stroke adjustment member. The knob is partially exposed to the housing. The first stroke adjustment member is located in the housing and includes a first end and a second end opposite to each other and a first pivot located between the first end and the second end. The first end is connected to the focal length adjustment device. The knob is connected to the second end. The knob rotates to drive the first stroke adjustment member to rotate around the first pivot. A distance between the first pivot and the first end is less than a distance between the first pivot and the second end, such that a movement path of the first end is less than a movement path of the second end, so as to fine-tune the focal length adjustment device.

In an embodiment of the disclosure, the focal length adjustment mechanism further includes a second stroke adjustment member, which includes a third end, a fourth end, and a second pivot. The third end is coupled to the second end, the fourth end is coupled to the knob, and a distance between the second pivot and the third end is less than a distance between the second pivot and the fourth end.

In an embodiment of the disclosure, the second end includes multiple first gears, the third end includes multiple second gears, and at least one of the first gears meshes with at least one of the second gears.

In an embodiment of the disclosure, the fourth end includes multiple third gears, the knob includes multiple fourth gears, and at least one of the third gears meshes with at least one of the fourth gears.

In an embodiment of the disclosure, the focal length adjustment mechanism further includes a damper, which is set on at least one of the knob, the first stroke adjustment member, and the second stroke adjustment member to increase rotational resistance of the at least one of the knob, the first stroke adjustment member, and the second stroke adjustment member.

In an embodiment of the disclosure, the damper is set at least on the first stroke adjustment member.

In an embodiment of the disclosure, the damper includes a pressing member, which is set on the first pivot and puts pressure on the first pivot along an axial direction of the first pivot.

In an embodiment of the disclosure, the damper further includes a buffer member, which is set between the pressing member and the first pivot. The buffer member is deformed by pressure of the pressing member.

In an embodiment of the disclosure, the buffer member includes a sponge, a rubber, a silica gel, or a spring.

In an embodiment of the disclosure, the focal length adjustment mechanism further includes a damper, which is set on at least one of the knob and the first stroke adjustment member to increase rotational resistance of at least one of the knob and the first stroke adjustment member. The damper includes at least one of a pressing member, a buffer member, a pair of magnetic attraction members, a damping oil, and an interference structure.

In an embodiment of the disclosure, the first end includes two cantilevers. The two cantilevers clamp the focal length adjustment device tightly.

In an embodiment of the disclosure, each of the cantilevers includes a clamping surface that contacts the focal length adjustment device. The clamping surface is arc-shaped.

In an embodiment of the disclosure, each of the cantilevers includes a clamping surface that contacts the focal length adjustment device. The clamping surface is flat.

As described above, the focal length adjustment mechanism of the disclosure may be used to adjust the focal length adjustment device located in the housing of the projector. The first end of the first stroke adjustment member is connected to the focal length adjustment device. The knob is connected to the second end. The knob of the focal length adjustment mechanism is partially exposed to the housing for operation by a user. Therefore, the knob may be rotated by the user, thereby driving the first stroke adjustment member to rotate around the first pivot, such that the focal length adjustment device moves, so as to achieve external focusing. In addition, the distance between the first pivot and the first end is less than the distance between the first pivot and the second end, such that the movement path of the first end is less than the movement path of the second end. Therefore, even if the user rotates the knob by a relatively large amplitude, the first stroke adjustment member can reduce the movement path of the first end through the leverage effect, thereby achieving fine-tuning of the focal length adjustment device. Therefore, the focal length adjustment mechanism of the disclosure is convenient for operation by the user, can provide more precise fine-tuning, and is suitable to be applied in projectors of various sizes.

### BRIEF DESCRIPTION OF THE DRAWINGS

FIG. 1 is a schematic view of a focal length adjustment mechanism applied in a projector according to an embodiment of the disclosure.

FIG. 2 is a top schematic view of FIG. 1.

FIG. 3 is a top view of a first end of a focal length adjustment mechanism according to another embodiment of the disclosure.

FIG. 4 is a schematic view of a focal length adjustment mechanism applied in a projector according to another embodiment of the disclosure.

### DESCRIPTION OF THE EMBODIMENTS

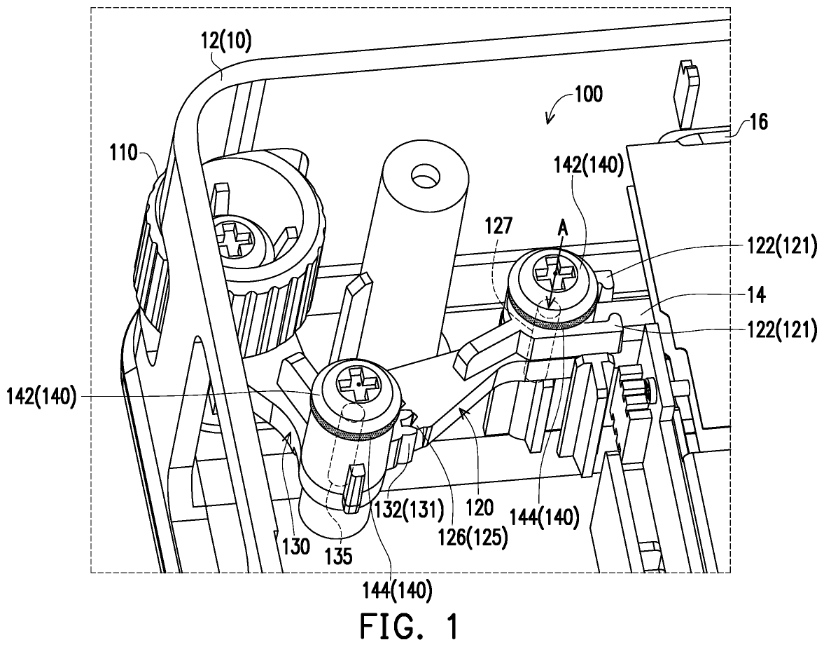

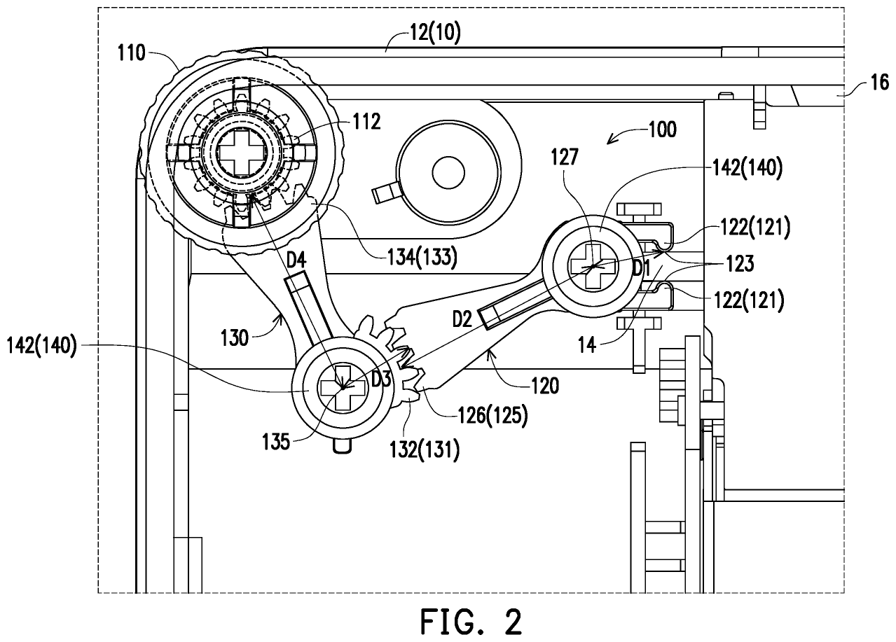

FIG. 1 is a schematic view of a focal length adjustment mechanism applied in a projector according to an embodiment of the disclosure. FIG. 2 is a top schematic view of FIG. 1. It should be noted that a top cover of the projector is removed in FIG. 1 and FIG. 2. In order to keep the drawings simple, only a part of the projector and elements related to the disclosure are drawn schematically, while other components are hidden.

Referring to FIG. 1 and FIG. 2, a focal length adjustment mechanism 100 of the disclosure is adapted for adjusting a focal length adjustment device 14 located in a housing 12 of a projector 10. In this embodiment, the focal length adjustment device 14 is a rod, and the focal length adjustment device 14 is connected to a lens 16. Therefore, the focal length adjustment mechanism 100 of the disclosure may be used to adjust the focal length of the lens 16, so that a projected image can be focused on a projection screen (not shown).

In this embodiment, the focal length adjustment mechanism 100 includes a knob 110 and a first stroke adjustment member 120. The knob 110 is partially exposed to the housing 12 for toggling the knob 110 by a user.

The first stroke adjustment member 120 is located in the housing 12 and includes a first end 121 and a second end 125 opposite to each other and a first pivot 127 (located in the inner part of FIG. 1, indicated by a dashed line) located between the first end 121 and the second end 125.

The first end 121 is connected to the focal length adjustment device 14. Specifically, as shown in FIG. 2, in this embodiment, the first end 121 includes two cantilevers 122. Each of the cantilevers 122 includes a clamping surface 123 that contacts the focal length adjustment device 14. The two cantilevers 122 clamp the focal length adjustment device 14 tightly through two clamping surfaces 123. In this embodiment, the clamping surface 123 is arc-shaped, but the shape of the clamping surface 123 is not limited thereto.

The knob 110 is connected to the second end 125. That is, a movement of the knob 110 drives the second end 125 to move. Specifically, in this embodiment, the focal length adjustment mechanism 100 further includes a second stroke adjustment member 130. The second stroke adjustment member 130 is located between the knob 110 and the second end 125.

The second stroke adjustment member 130 includes a third end 131, a fourth end 133 (FIG. 2), and a second pivot 135 (located in the inner part of FIG. 1, indicated by a dashed line). The third end 131 is coupled to the second end 125, and the fourth end 133 is coupled to the knob 110. That is, the knob 110 is connected to the second end 125 of the first stroke adjustment member 120 through the second stroke adjustment member 130.

In this embodiment, the second end 125 includes multiple first gears 126, the third end 131 includes multiple second gears 132, and at least one of the first gears 126 meshes with at least one of the second gears 132, such that the third end 131 is coupled to the second end 125.

In addition, as shown in FIG. 2, the fourth end 133 includes multiple third gears 134, the knob 110 includes multiple fourth gears 112, and at least one of the third gears 134 meshes with at least one of the fourth gears 112, such that the fourth end 133 is coupled to the knob 110.

Certainly, in other embodiments, the third end 131 is coupled to the second end 125 and the fourth end 133 is coupled to the knob 110 by means of linkage, clamping, pivoting, riveting, etc., and is not limited thereto, as long as the third end 131 may be connected to the second end 125 and the fourth end 133 may be connected to the knob 110.

In this embodiment, the knob 110 of the focal length adjustment mechanism 100 is partially exposed to the housing 12 for operation by the user. Therefore, the knob 110 may be rotated by the user, thereby driving the fourth end 133 of the second stroke adjustment member 130 to move. The second stroke adjustment member 130 rotates correspondingly around the second pivot 135, and the third end 131 of the second stroke adjustment member 130 moves to drive the second end 125 of the first stroke adjustment member 120 to move. The first stroke adjustment member 120 rotates correspondingly around the first pivot 127 to drive the first end 121 of the first stroke adjustment member 120 to move, thereby moving the focal length adjustment device 14, so as to achieve external focusing.

It should be noted that, in this embodiment, the number of the stroke adjustment members of the focal length adjustment mechanism 100 is, for example, two, but in other embodiments, the number of the stroke adjustment members is not limited thereto, which may be a single one or more than two, and the designer can adjust the number according to requirements and space configuration.

It is worth mentioning that, in FIG. 2, as the first stroke adjustment member 120 rotates around the first pivot 127, when the first stroke adjustment member 120 rotates, the movement path of the first end 121 is around the first pivot 127, a distance D1 between the first pivot 127 and the first end 121 is an arc formed by the radius (not shown), the movement path of the second end 125 is around the first pivot 127, and a distance D2 between the first pivot 127 and the second end 125 is an arc formed by the radius (not shown).

In this embodiment, the distance D1 between the first pivot 127 and the first end 121 is less than the distance D2 between the first pivot 127 and the second end 125, such that when the first stroke adjustment member 120 rotates around the first pivot 127, the movement path of the first end 121 is less than the movement path of the second end 125.

In this embodiment, the distance D2 between the first pivot 127 and the second end 125 is, for example, three times the distance D1 between the first pivot 127 and the first end 121, but the multiple may vary depending on the number of times the movement path is reduced and is not limited thereto.

Similarly, as the second stroke adjustment member 130 rotates around the second pivot 135, when the second stroke adjustment member 130 rotates, the movement path of the third end 131 is around the second pivot 135, a distance D3 between the second pivot 135 and the third end 131 is an arc formed by the radius (not shown), the movement path of the fourth end 133 is around the second pivot 135, and a distance D4 between the second pivot 135 and the fourth end 133 is an arc formed by the radius (not shown).

In this embodiment, the distance D3 between the second pivot 135 and the third end 131 is less than the distance D4 between the second pivot 135 and the fourth end 133, such that when the second stroke adjustment member 130 rotates around the second pivot 135, the movement path of the third end 131 less than the movement path of the fourth end 133.

In this embodiment, the distance D4 between the second pivot 135 and the fourth end 133 is, for example, three times the distance D3 between the second pivot 135 and the third end 131, but the multiple may vary depending on the number of times the movement path is reduced and is not limited thereto.

With the design described above, when the user toggles the knob 110, a rotational stroke of the knob 110 is related to the length of the movement path of the fourth end 133 of the second stroke adjustment member 130. Since the second stroke adjustment member 130 rotates around the second pivot 135, the rotational angle of the third end 131 is the same as the rotational angle of the fourth end 133. However, since the distance D3 is less than the distance D4, the movement path of the third end 131 may be reduced to, for example, ⅓ times the length of the movement path of the fourth end 133.

In addition, the length of the movement path of the second end 125 of the first stroke adjustment member 120 is related to the length of the movement path of the third end 131 of the second stroke adjustment member 130. Since the first stroke adjustment member 120 rotates around the first pivot 127, the rotational angle of the first end 121 is the same as the rotational angle of the second end 125. However, since the distance D1 is less than the distance D2, the movement path of the first end 121 may be further reduced to, for example, ⅓ times the length of the movement path of the second end 125.

In other words, in this embodiment, with the design described above, the movement path of the first end 121 is about 1/9 times the rotational length of the knob 110. Therefore, even if the user rotates the knob 110 by a relatively large amplitude, the focal length adjustment mechanism 100 can enable the focal length adjustment device 14 to move only a little bit by the design of the first stroke adjustment member 120 and the second stroke adjustment member 130, so that the focal length adjustment device 14 can achieve fine-tuning. As a result, the focal length adjustment mechanism 100 is suitable to be applied in the projector 10 of various sizes, especially the projector 10 of a small size. In addition, the user does not need to rotate the knob 110 by a very small amplitude to fine-tune the lens 16, so the operation is relatively simple and convenient.

Besides, when the focal length is well adjusted, in order for the lens 16 maintain stably in a specific position to fix the adjusted focal length and to keep the projected image clear, in this embodiment, the focal length adjustment mechanism 100 further includes a damper 140. The damper 140 is set on at least one of the knob 110, the first stroke adjustment member 120, and the second stroke adjustment member 130 to increase the rotational resistance of the at least one of the knob 110, the first stroke adjustment member 120, and the second stroke adjustment member 130.

In an embodiment, the damper 140 is set at least on the first stroke adjustment member 120 to maintain the position of the first end 121. Specifically, as shown in FIG. 1, in this embodiment, the damper 140 includes, for example, a pressing member 142, and the pressing member 142 is, for example, a screw, but not limited thereto. The pressing member 142 (the pressing member 142 on the right) is set on the first pivot 127 and puts pressure on the first pivot 127 along an axial direction A of the first pivot 127. Therefore, the first stroke adjustment member 120 at the first pivot 127 is subjected to the friction formed by the downward pressure of the pressing member 142 and will not rotate freely. As a result, the position of the first end 121 can be maintained.

In addition, in this embodiment, the damper 140 is also set on the second stroke adjustment member 130. Specifically, the pressing member 142 (the pressing member 142 on the left) of the damper 140 is set on the second pivot 135 to put downward pressure on the second pivot 135. Therefore, the second stroke adjustment member 130 at the second pivot 135 is subjected to the friction formed by the downward pressure of the pressing member 142 and will not rotate freely. The position of the fourth end 133 can be maintained. As a result, the position of the knob 110 is also maintained. When the user overcomes the friction by exerting a force to rotate the knob 110, the second stroke adjustment member 130 and the first stroke adjustment member 120 are rotated.

As shown in FIG. 1, the damper 140 may also selectively include a buffer member 144. The buffer member 144 includes a sponge, a rubber, a silica gel, or a spring. The buffer member 144 is set between the pressing member 142 and the first pivot 127. The buffer member 144 is deformed by the pressure of the pressing member 142. Such a design enables the pressing member 142 to adjust the downward pressure through the buffer member 144, so as to prevent excessive friction on the first pivot 127.

Certainly, an assembler may also provide different downward pressure through adjusting a screwing position of the pressing member 142 along the axial direction A. For example, when the pressing member 142 is locked deeper, the downward pressure on the first pivot 127 is greater; and when the pressing member 142 is locked shallower, the downward pressure on the first pivot 127 is smaller. Therefore, the buffer member 144 may also be omitted.

It should be noted that, in this embodiment, the damper 140 is a combination of the pressing member 142 and the buffer member 144, but the type of the damper 140 is not limited thereto. In other embodiments, the damper 140 may also be at least one of a pair of magnetic attraction members, a damping oil, and an interference structure. In an embodiment, the damping oil may be added to a gap between the first pivot 127 or/and the second pivot 135 and a corresponding hole, so as to provide resistance. In an embodiment, an interference structure may be set between the first pivot 127 or/and the second pivot 135 and the corresponding hole, so as to provide resistance. The form of the pair of magnetic attraction members is described below.

Other forms of the focal length adjustment mechanism are described below, elements that are the same or similar with the previous embodiment are indicated by the same or similar reference numerals without further elaboration, and only main differences will be explained below.

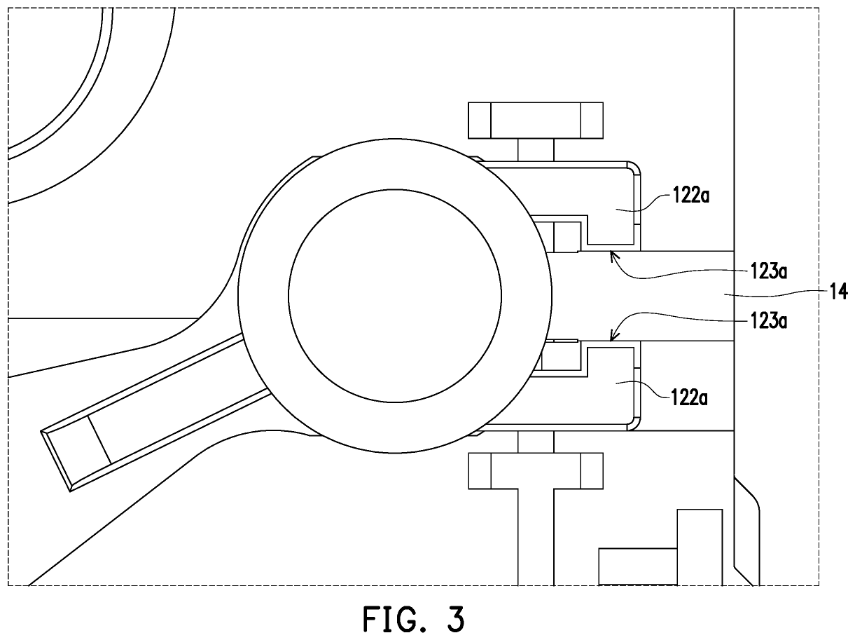

FIG. 3 is a top view of a first end of a focal length adjustment mechanism according to another embodiment of the disclosure. Referring to FIG. 3, the main difference between this embodiment and the previous embodiment is that, in this embodiment, a clamping surfaces 123a of each cantilever 122a is flat. Therefore, two clamping surfaces 123a are able to clamp the focal length adjustment device 14 with a large contact area.

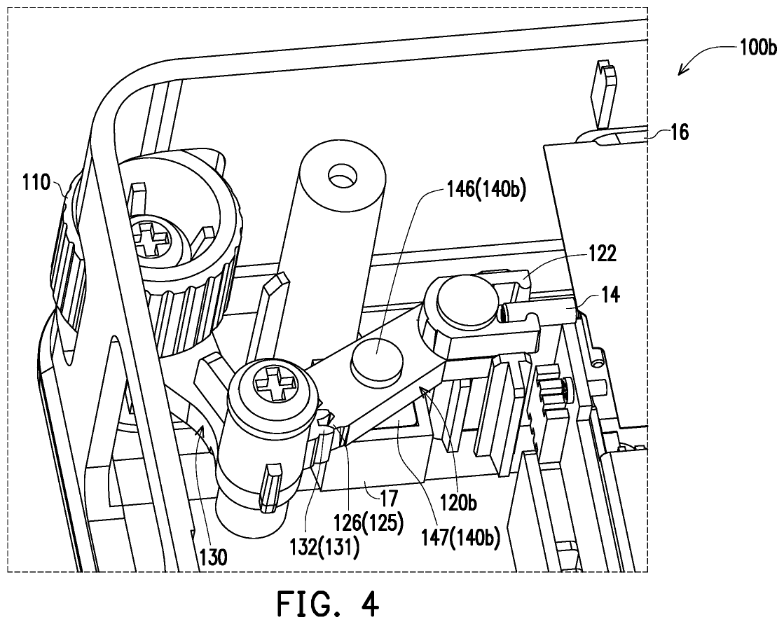

FIG. 4 is a schematic diagram of a focal length adjustment mechanism applied in a projector according to another embodiment of the disclosure. Referring to FIG. 4, the main differences between this embodiment and FIG. 1 are the types and the positions of dampers 140 and 140b. In this embodiment, the damper 140b of a focal length adjustment mechanism 100b includes a pair of magnetic attraction members 146 and 147. Specifically, the pair of magnetic attraction members 146 and 147 are, for example, two magnets with ends with opposite polarities facing each other. For example, the N pole of the magnetic attraction member faces the S pole of the magnetic attraction member, or the S pole of the magnetic attraction member faces the N pole of the magnetic attraction member. In an embodiment, one of the magnetic attraction members 146 and 147 may be a magnet, while the other one is a metal that can be attracted by the magnet.

In this embodiment, the magnetic attraction member 146 is set on a first stroke adjustment member 120b and is located between the first pivot 127 (indicated in FIG. 1) and the second end 125, while the magnetic attraction member 147 is set on a base 17. The base 17 is located inside the housing and is fixed to the housing. Therefore, the first stroke adjustment member 120b is pulled down by the magnetic force toward the direction of the base 17, which increases the friction with the base 17, thereby providing resistance.

The magnetic attraction member 146 may be set on the first stroke adjustment member 120b by spot gluing or back adhesion, and the magnetic attraction member 147 may be set on the base 17 also by spot gluing or back adhesion. Setting manners are not limited thereto. In addition, the shapes of the magnetic attraction member 146 and the magnetic attraction member 147 are not limited, and the shapes of the magnetic attraction member 146 and the magnetic attraction member 147 may be the same or different. For example, the magnetic attraction member 146 is circular and the magnetic attraction member 147 is square, but not limited thereto.

In addition, the size of the magnetic attraction member 147 may be larger than the magnetic attraction member 146, such that when the first stroke adjustment member 120b moves, the magnetic attraction member 146 may still be attracted by the magnetic attraction member 147. Certainly, as long as the magnetic attraction member 146 can be attracted by the magnetic attraction member 147 within the movement range.

In summary, the focal length adjustment mechanism of the disclosure may be used to adjust the focal length adjustment device located in the housing of the projector. The first end of the first stroke adjustment member is connected to the focal length adjustment device. The knob is connected to the second end. The knob of the focal length adjustment mechanism is partially exposed to the housing for operation by a user. Therefore, the knob may be rotated by the user, thereby driving the first stroke adjustment member to rotate around the first pivot, such that the focal length adjustment device moves, so as to achieve external focusing. In addition, the distance between the first pivot and the first end is less than the distance between the first pivot and the second end, such that the movement path of the first end is less than the movement path of the second end. Therefore, even if the user rotates the knob by a relatively large amplitude, the first stroke adjustment member can reduce the movement path of the first end through the leverage effect, thereby achieving fine-tuning of the focal length adjustment device. Therefore, the focal length adjustment mechanism of the disclosure is convenient for operation by the user, can provide more precise fine-tuning, and is suitable to be applied in projectors of various sizes.

What is claimed is:

1. A focal length adjustment mechanism, adapted for adjusting a focal length adjustment device located in a housing of a projector, the focal length adjustment mechanism comprising:
a knob, partially exposed to the housing; and
a first stroke adjustment member, located in the housing and comprising a first end and a second end opposite to each other and a first pivot located between the first end and the second end, wherein the first end is connected to the focal length adjustment device, and the knob is connected to the second end, wherein
the knob rotates to drive the first stroke adjustment member to rotate around the first pivot, a distance between the first pivot and the first end is less than a distance between the first pivot and the second end, such that a movement path of the first end is less than a movement path of the second end, so as to fine-tune the focal length adjustment device.

2. The focal length adjustment mechanism according to claim 1, further comprising:
a second stroke adjustment member, comprising a third end, a fourth end, and a second pivot, wherein the third end is coupled to the second end, the fourth end is coupled to the knob, and a distance between the second pivot and the third end is less than a distance between the second pivot and the fourth end.

3. The focal length adjustment mechanism according to claim 2, wherein the second end comprises a plurality of first gears, the third end comprises a plurality of second gears, and at least one of the plurality of first gears meshes with at least one of the plurality of second gears.

4. The focal length adjustment mechanism according to claim 2, wherein the fourth end comprises a plurality of third gears, the knob comprises a plurality of fourth gears, and at least one of the plurality of third gears meshes with at least one of the plurality of fourth gears.

5. The focal length adjustment mechanism according to claim 2, further comprising:
a damper, set on at least one of the knob, the first stroke adjustment member, and the second stroke adjustment member to increase rotational resistance of the at least one of the knob, the first stroke adjustment member, and the second stroke adjustment member.

6. The focal length adjustment mechanism according to claim 5, wherein the damper is set at least on the first stroke adjustment member.

7. The focal length adjustment mechanism according to claim 5, wherein the damper comprises a pressing member set on the first pivot and putting pressure on the first pivot along an axial direction of the first pivot.

8. The focal length adjustment mechanism according to claim 7, wherein the damper further comprises a buffer member set between the pressing member and the first pivot, and the buffer member is deformed by pressure of the pressing member.

9. The focal length adjustment mechanism according to claim 8, wherein the buffer member comprises a sponge, a rubber, a silica gel, or a spring.

10. The focal length adjustment mechanism according to claim 1, further comprising:
a damper, set on at least one of the knob and the first stroke adjustment member to increase rotational resistance of the at least one of the knob and the first stroke adjustment member, wherein the damper comprises at least one of a pressing member, a buffer member, a pair of magnetic attraction members, a damping oil, and an interference structure.

11. The focal length adjustment mechanism according to claim 1, wherein the first end comprises two cantilevers, and the two cantilevers clamp the focal length adjustment device tightly.

12. The focal length adjustment mechanism according to claim 11, wherein each of the cantilevers comprises a clamping surface contacting the focal length adjustment device, and the clamping surface is arc-shaped.

13. The focal length adjustment mechanism according to claim 11, wherein each of the cantilevers comprises a clamping surface contacting the focal length adjustment device, and the clamping surface is flat.
